(19) United States
(12) Patent Application Publication
(10) Pub. No.: US 2012/0124956 A1
(43) Pub. Date: May 24, 2012

(54) Method and Apparatus for Harvesting a Grain Crop

(76) Inventor: Scott D. Oakes, Waukee, IA (US)

(21) Appl. No.: 13/296,945

(22) Filed: Nov. 15, 2011

Related U.S. Application Data
(60) Provisional application No. 61/415,135, filed on Nov. 18, 2010.

(51) Int. Cl. A01D 37/00

(52) U.S. Cl. 56/131

(57) ABSTRACT

A method and an apparatus for harvesting grain crops wherein the crop (grain included) is first baled, then combined. All parts of the plant may be separated and baled according to value or the entire plant may be baled. The baled form remains until the grain is needed for delivery. Then, bales are combined by a quasi-stationary combine apparatus to separate the grain which is then conveyed and/or augered either to a storage bin or to a load-out bin under which a truck can drive and load. The remaining plant parts are re-baled by a baler associated with the quasi-stationery combine. The benefits of this method are many and include reduction in need for large combines, labor at harvest time, traffic on roads, wait time at elevators, and soil compaction in addition to providing grain marketing advantages.

### PRIORITY CLAIMS

This nonprovisional patent application claims the priority of provisional application No. 61/415,135.

### FIELD OF INVENTION

The present invention relates to a method and select equipment for use in harvesting grains crops, more specifically, a method that reduces harvest-time labor, soil compaction, fuel costs, and capital equipment investment while providing the producer more freedom in timing relative to marketing efforts.

### BACKGROUND

Crops such as soybeans, corn, sorghum, wheat and other similar grains are typically harvest by harvesting machines driven by people across the field. The harvesting machine is equipped with a cutting mechanism at the front which cuts the plant at the stem or stalk and feeds it into a combine head, often via a horizontally rotating reel equipped with tines to guide the plants into the head. The head is equipped with mechanical means and cutters to separate grain from the other plant parts. The grain is then moved via conveyor mechanism to a temporary storage container called a hopper on the machine. An auger for unloading the grain is associated with the hopper. The remaining plant parts are simply ejected back onto the field.

The temporary storage container or hopper on the machine is relatively small and often needs to be emptied mid-field. To accomplish this, a catch cart (typically a tractor and wagon) is driven near, the harvesting machine augers the grain from the temporary storage container and dumps grain into the wagon positioned below while the machine and tractor are moving. Once empty, the harvesting machine continues, and the catch cart takes the grain to a place where additional equipment is available to auger or otherwise transport the grain from the cart to semi-trucks. The trucks, then, move the grain away from the field to more permanent sorts of storage containers such as bins or to the grain elevator. Often, the grain is wetter than the elevator will accept or will result in a reduction in price per bushel so the grain may be dried in the bin before delivering it to the elevator.

When the truck arrives at the grain elevator, so many other producers are harvesting at the same time, that it is not unusual for a truck and driver to need to wait an hour or more to unload. This increases the need for more trucks in the operation so the harvesting machine or machines can keep working.

The need to gather the crop in a short time while weather lasts and in such a manner as to maximize the flow of grain to storage has driven harvesting machines to become bigger and more powerful. These two characteristics, in turn, create machines that are heavier, harder to transport from field to field on roads because the width of the head increases to gather more grain in a single swath, and machines that are higher fuel consumers. Further, the operation of these large machines results in more soil compaction. The price on these machines increases in relationship to power and capacity.

The current method of harvesting is incredibly labor intensive over a short period of time. It requires a driver for the harvesting machine, driver of catch cart, unload/loading operators, multiple trucks and multiple truck drivers to keep the grain moving out of the field and enough empty containers to avoid bottlenecking and causing a lull in the process. Obtaining enough labor for a 2-4 week period is challenging in most rural areas, and the astronomical increase in truck and equipment traffic on the roads causes numerous accidents every year, not to mention the traffic headaches on certain stretches of road. The fast paced nature is partially driven by weather, and mostly driven by the condition of the grain. Further, because many producers do not have grain storage capacity for all the grain they produce, the producer is driven either to market the grain sooner (when other producers are also flooding the market with grain and prices are often among the lowest for the year) or store the grain in grain elevators prior to sale where storage costs mount over time.

A new method for harvesting grains, and specifically designed equipment, was needed to allow marketing to occur more remote in time, to reduce truck traffic congestion at harvest time, and lessen the amount of labor required for harvest. Further, a method was needed to reduce the capital cost in machines, fuel consumption, soil compaction and sheer size. A new method was needed to also reduce the time required for offloading transported grain and to reduce the costs of drying and/or to store the grain in a manner that preserves the grain's moisture level.

### SUMMARY OF THE INVENTION

The present invention reduces the power, size, weight and fuel consumption required for harvesting machines. The new method includes harvesting the grain whole with the stalk and stem parts and separating some or all of them only after the harvest, sometimes months later. The method binds at least some plant parts—grain intact—together in large bundles or bales of plant materials. These bales are produced in the field and can be left where they are produced, and then transported later to a more convenient location if desired. In the preferred embodiment, the bales are covered, or wrapped, or substantially enveloped in a material that protect from moisture. In any event, the bales do not require a storage shed, bin or even a roof and can be stored in the field until the producer desires to deliver grain. In a most preferred embodiment, the material is antimicrobial.

When the producer wishes to separate the grain from the remaining baled plant parts, the bales are fed into a quasi-stationary combine mechanism. This mechanism is not required to cut any swath across a field and so only needs to have a width adequate to feed material from the bale. It also need not (although it may) be self-propelling, and does not need a temporary storage container albeit one may be present. In addition to the quasi-stationary combine, a load-out bin is provided. This load-out bin is preferably comprised of a hopper bottom and is raised so that trucks may easily drive under it to be filled. Grain is augered or otherwise transported from the quasi-stationary combine to the load-out bin.

Optionally, the separated remaining plant parts can be fed from the quasi-stationary combine to a baling unit and rebaled for animal feed or other purposes.

### DRAWINGS

FIG. 1 depicts a plan view of the vehicles and harvesting machine in the field while using a prior art method of harvesting;

FIG. 2 depicts a plan view of the loading method of the prior art;

FIG. 3a is a plan view schematic of the new harvesting machine, single baler;

FIG. 3b is a plan view schematic of the new harvesting machine, plural balers;

FIG. 4 is an end view drawing of a wrapped bale;

FIG. 5 is a perspective drawing of a wrapped bale;

FIG. 6 is a plan view schematic of a first embodiment of the quasi-stationary combine system;

FIG. 7 is a side view schematic of the load-out bin; and

FIG. 8 is a side view schematic of one embodiment of the present invention comprising the quasi-stationary combine system, the load-out bin, and a truck.

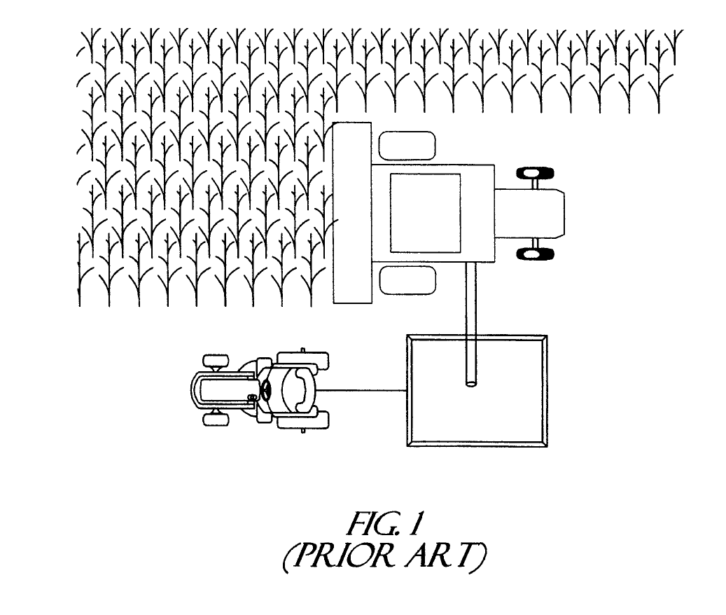

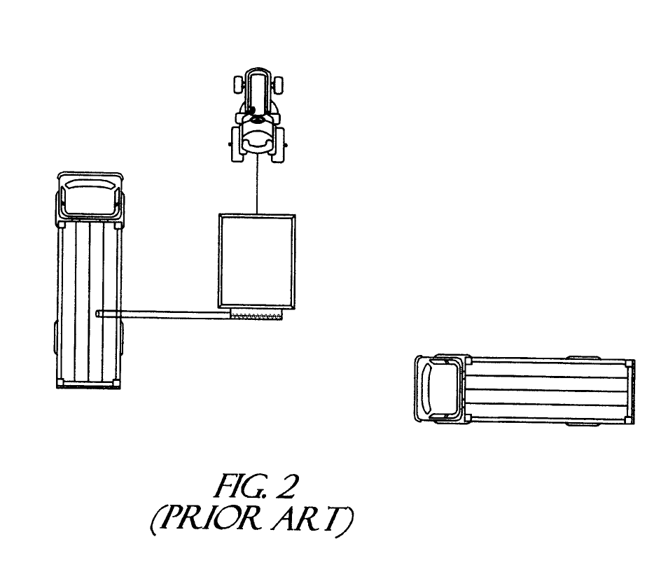

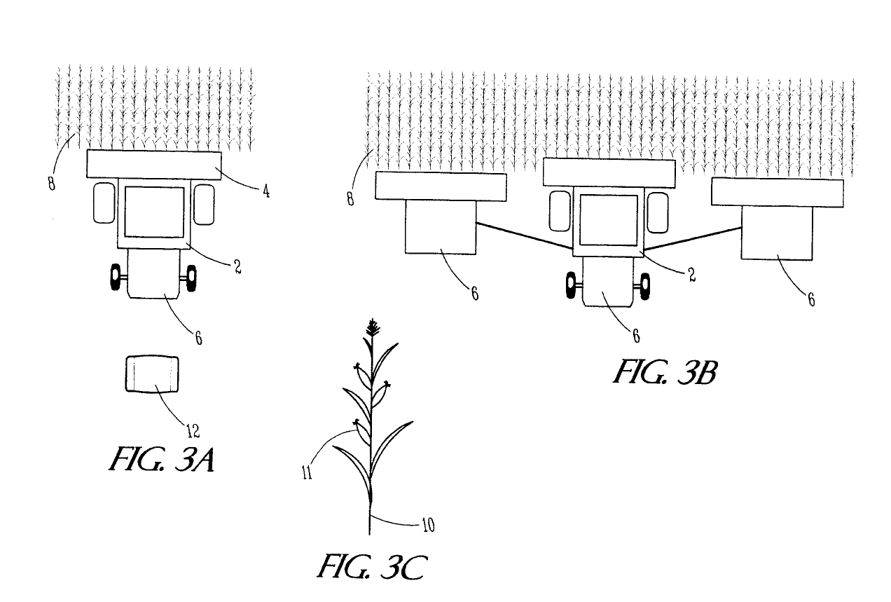

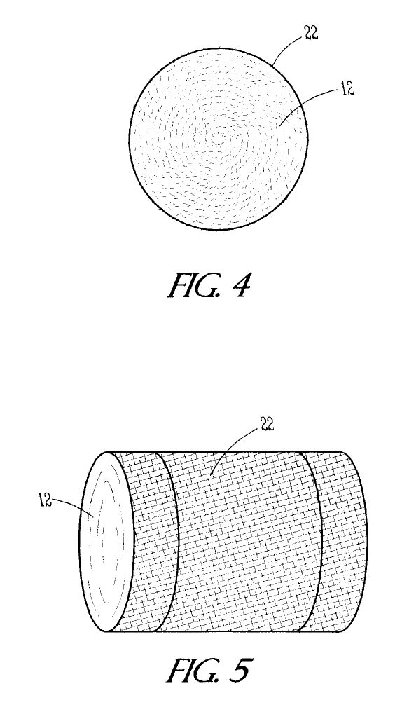

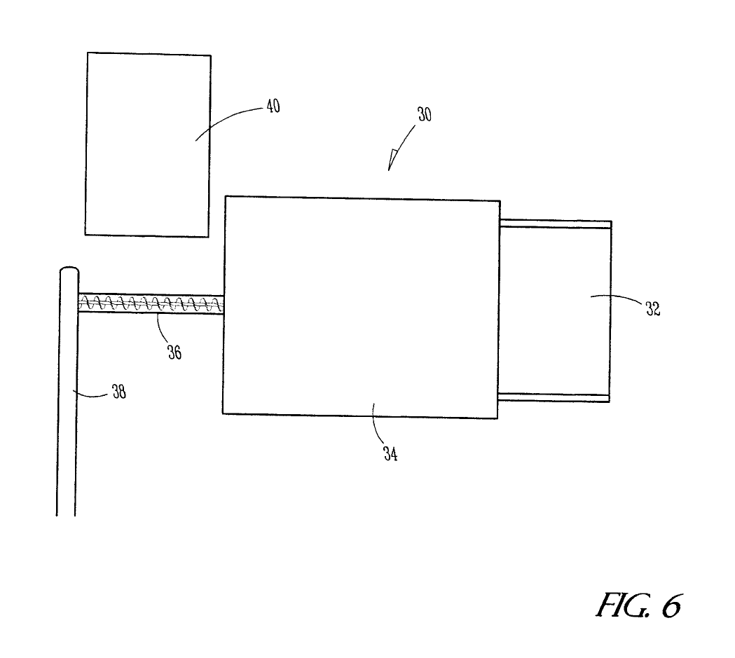

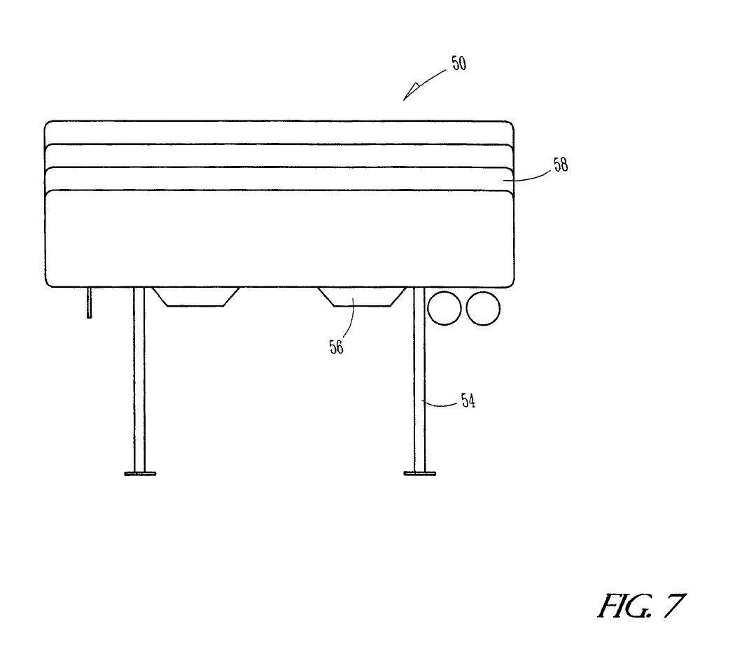

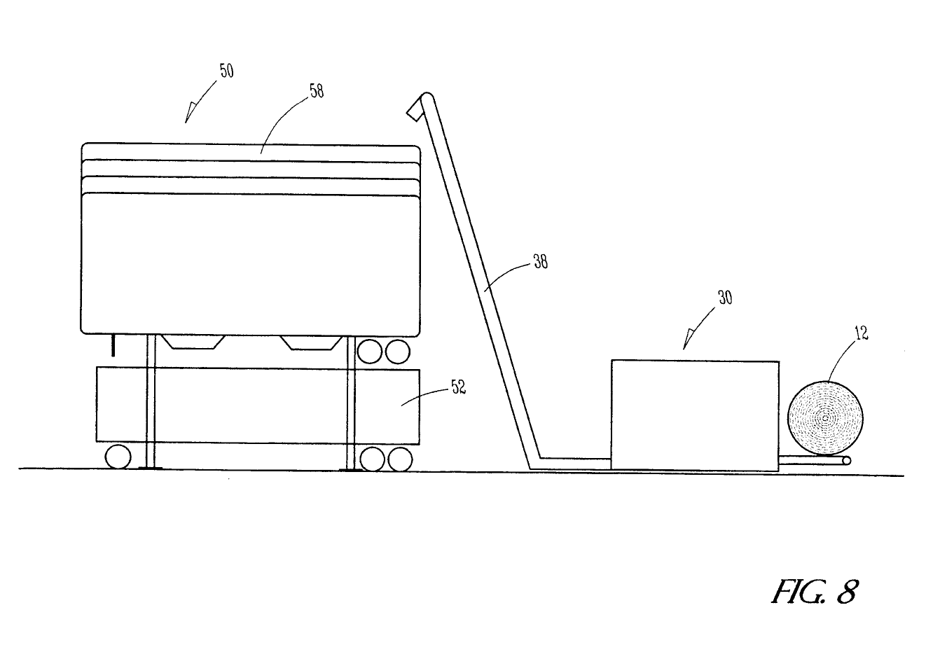

### DETAILED DESCRIPTION OF THE INVENTION

The present method and specialized equipment is described below in detail. However, this description is one of example and not of limitation. It is recognized that a variety of different adaptations to current machines may be made to accomplish some of the same effect and it is intended that this disclosure contemplates those that would be obvious to persons of skill in the art.

The present method comprises a harvesting machine 2 including at least one cutting bar 4 and at least one baling mechanism 6. This machine is driven across a field 8, cuts the whole plant 10 including grain 11 and bales it or some portion of it into a bale 12 creating a plurality of bales 12. The bales 12 may be left where they are finished and later gathered. Preferably, the baling mechanism 6 includes means to wrap the bale 20 in antimicrobial material 22 as part of the baling process, but it will be appreciated that the bale 12 could be covered after or before it is transported, and may be either partially or fully wrapped, or simply covered and the material 22 may not be antimicrobial. Round bales 12 are preferred albeit not necessary, and both John Deere and Vermeer Mfg. make biomass balers that would suffice.

The bales 12 can be stored without building or roof, perhaps simply lined up in a now bare field 8, waiting for the time the grain 11 is to be separated from the plant 10 or plant parts. The bales 12 may be stored near a quasi-stationary combine apparatus 30, or may be moved to where a quasi-stationary combine apparatus 30 is positioned. Alternatively, the quasi-stationary combine apparatus 30 may be transported to and set up near where the bales 12 are stored. Bales 12 may be wrapped at time of harvest if the moisture content of the grain 11 is at a desirable level, or may be covered later after allowing some dry down if necessary.

When the producer desires to separate the grain 11 from the plants 10 or plant parts, the quasi-stationary combine apparatus 30 is employed. For reduction of weight, cost and size purposes, the quasi-stationary combine apparatus 30 is preferably not self-propelled but, instead, comprises either a conveyor or a horizontally rotating reel with tines or other means for moving the bale 32 into the apparatus. A smaller combine unit may be salvaged from an older machine such as a John Deere 7700 or equivalent, and used in the present invention as the combine 34 in the quasi-stationery combine apparatus 30. It may, but does not need to include, a temporary grain storage container 34. The preferred embodiment does not include a temporary grain storage container. Once fed into the apparatus 30, the grain 11 is separated from the plant parts 10 in the same way self-propelled combines accomplish the task, which is old in the art. The quasi-stationary combine apparatus 30 further comprises means to move 36 the separated grain 11. In a preferred embodiment, the means to move the grain may comprise an auger or elevator and the apparatus 30 further comprises a conveyor 38 or similar apparatus for accepting the grain 11 from the auger 36 and moving the grain 11 out from the apparatus 30. The remaining plant parts 10 are emptied separate from the grain 11. In another preferred embodiment, the quasi-stationary combine apparatus 30 may include or be associated with a baling mechanism 40 for re-baling the remaining plant parts 10.

The method then requires transport of the grain 11 from the quasi-stationary combine apparatus 30 either to a bin or to trucks for transportation to point of sale. If the grain 11 will be stored in a bin, then the producer is likely to move or store the bales near the bin, and then position the quasi-stationary combine 30 near the bin as well. The conveyor 38 may be set to move the grain 11 directly to the bin from the quasi-stationary combine apparatus 30.

Alternatively, if the grain 11 is to be transported to a bin, or grain elevator or other point of sale, a load-out bin 50 may be employed. This load-out bin 50 is preferably) positioned such that a truck 52 may be driven under it to receive the grain. In the most preferred embodiment, the load-out bin 50 is positioned on supports 54 through which a truck 52 can be driven, fashioned with a hopper bottom 56, and preferably includes extendable sides 58 so that more than a single truck load of grain can be contained therein. The size and position of the load-out bin 50 provide a fast and efficient method of loading trucks whereby an empty truck 52 drives under the bin 50, is loaded, and drives out with another following. The extendable sides 58 eliminate or reduce wait time between trucks. The person of ordinary skill in the art will appreciate that the load bin 50 may alternatively be positioned over a pit into which trucks are driven or cantilevered from a stationary platform and supported by any adequate means.

The efficiencies of the present invention are evident. It provides a means for the producer to harvest the crop using a single harvesting machine without catch cart, multiple trucks, or elevator unloading wait time, thereby reducing the need for labor, and the urgency that otherwise accompanies the harvest process. The method of the invention reduces fuel consumption, weight and soil compaction of the harvesting machine by reducing the amount of power needed to combine large swaths of crop in a single pass. This reduction is also a result of simplifying the harvesting machine and the process of off-loading grain from the temporary storage container of the prior art harvesting machines. Reducing the size of the harvesting machine also improves its transportability.

If used as presented herein in a preferred embodiment, the method would eliminate the need for many trucks to be on the road at once, and eliminate the need for grain storage facilities for the entire crop. By spreading the harvest operation over time without the need to pay storage fees, the producer is better able to market the crop, thereby providing the producer with more opportunity to optimize his profit margins. This method may be employed by a single small producer doing most of the labor alone or a large producer simply by scaling up the number of harvesting machines and quasi-stationary combine apparatuses.

What I claim is:

1. A method for harvesting a grain crop from plants comprising the steps of:
(a) cutting the plants including grain;
(b) baling the cut plants and grain together into a plurality of bales;
(c) marketing a pre-determined amount of said grain and arranging delivery;
(d) feeding at least some of the plurality of bales into a quasi-stationary combine apparatus to separate the grain from the plants;
(e) loading the grain into at least one transportable container;
(f) delivering the grain as arranged.

2. The method of claim 1 wherein said quasi-stationary combine apparatus comprises at least one auger for moving said grain to a transport vehicle.

3. The method of claim 1 wherein said quasi-stationary combine apparatus comprises means for moving said grain to a storage bin.

4. The method of claim 1 wherein said quasi-stationary combine apparatus is self-propelled.

5. The method of claim 1 wherein said quasi-stationary combine apparatus further comprises a baler to accept the plants from which the grain has been separated and form said plants into a bale.

6. The method of claim 1 wherein said quasi-stationary combine apparatus further comprises a load out bin.

7. The method of claim 6 wherein said load out bin comprises supports for positioning said load out bin above ground level and a hopper bottom for outloading the grain.

8. The method of claim 6 wherein said load out bin comprises extendible sides.

9. A method for harvesting a grain crop from plants comprising the steps of:
(a) cutting and baling the plants and grain together into a plurality of bales;
(b) feeding each of said plurality of bales into a quasi-stationary combine apparatus to separate the grain;
(c) transporting the separated grain to a storage container.

10. The method of claim 9 wherein said storage container is a grain elevator and transporting comprises moving the grain from the quasi-stationary combine apparatus first to a load-out bin, then to at least one transport vehicle.

11. The method of claim 10 wherein said load-out bin comprises a hopper-bottom.

12. The method of claim 11 wherein said load-out bin further comprises extendable sides for increasing the capacity of the load-out bin.

13. The method of claim 11 wherein the load-out bin is positioned above a surface by a height at least that of said at least one transport vehicle for allowing said vehicle to drive under the load-out bin.

14. The method of claim 10 wherein a harvesting machine is employed for the step of cutting and baling the plants, said harvesting machine being self-propelled and comprising means to bale.

15. The method of claim 10 wherein said quasi-stationary combine apparatus comprises a) a non-selfpropelled combine for separating said grain and said plants, and b) means for moving said grain

16. The method of claim 15 wherein said quasi-stationary combine apparatus further comprises a baling mechanism for re-baling the separated plant parts.

17. A quasi-stationary combine apparatus comprising means for moving a bale into the apparatus, a combine for separating grain from plant parts, and a baling mechanism for baling the plant parts from which grain has been separated.

18. The quasi-stationary combine apparatus of claim 17 further comprising means for moving grain from said quasi-stationary combine apparatus to a storage bin.

19. The quasi-stationary combine apparatus of claim 17 further comprising means for moving grain from said quasi-stationary combine apparatus to a transport vehicle.

20. The quasi-stationary combine apparatus of claim 17 further comprising a load-out bin positioned at least the height of the transport vehicle above a driving surface.
